(19) United States
(12) Patent Application Publication
(10) Pub. No.: US 2024/0191719 A1
(43) Pub. Date: Jun. 13, 2024

(54) CEILING FAN

(71) Applicant: HOTECK INC., Taichung City (TW)

(72) Inventors: Te-Yi CHEN, Taichung City (TW); Chia-Wei CHANG, Taichung City (TW); Min-Yuan HSIAO, Taichung City (TW)

(73) Assignee: HOTECK INC., Taichung City (TW)

(21) Appl. No.: 18/298,996

(22) Filed: Apr. 11, 2023

(30) Foreign Application Priority Data
Dec. 9, 2022 (TW) 111213648

(51) Int. Cl. F04D 27/00; F21V 33/00; G06F 3/01; G08C 17/00

(52) U.S. Cl. CPC F04D 27/00; F21V 33/0096; G06F 3/017; G08C 17/00

(57) ABSTRACT

A ceiling fan including a fan device and a remote control is provided. The fan device includes a motor and a control unit. The remote control includes a gesture sensing unit and a processing unit. The gesture sensing unit includes a sensing module that is configured to obtain a sense image of an object, and includes a storage medium that stores a plurality of data sets and different reference tracks that respectively correspond to the data sets. The processing unit is configured to: obtain a movement track of the object; obtain a corresponding one of the data sets when the movement track conforms with one of the reference tracks; and output a command that is related to said corresponding one of the data sets to the control unit. In response to receipt of the command, the control unit adjusts rotational speed of the motor according to the command.

### CROSS-REFERENCE TO RELATED APPLICATION

This application claims priority to Taiwanese Utility Model Patent Application No. 111213648, filed on Dec. 9, 2022.

### FIELD

The disclosure relates to a ceiling fan, and more particularly to a gesture controlled ceiling fan.

### BACKGROUND

A conventional ceiling fan includes a fan device that is adapted to be mounted on a ceiling of a room, and a remote control that is coupled to the fan device. A user may remotely adjust rotational speed of the fan device by operating the remote control.

However, the remote control may be contaminated with bacteria or viruses from users directly touching the button(s) thereof, thus increasing risks of spreading diseases.

### SUMMARY

Therefore, an object of the disclosure is to provide a ceiling fan that can alleviate at least one of the drawbacks of the prior art.

According to the disclosure, a ceiling fan includes a fan device and a remote control electrically connected to the fan device. The fan device includes a motor, and a control unit that is electrically connected to the motor and that is configured to adjust rotational speed of the motor. The remote control includes a gesture sensing unit and a processing unit. The gesture sensing unit includes a sensing module that is configured to obtain a sense image based on a sense signal reflected by an object, and a storage medium that stores a plurality of operation data sets that are related to adjusting rotational speed of the motor and different reference tracks that are respectively associated with the plurality of operation data sets. The processing unit is electrically connected to the sensing module and the storage medium, and is configured to: obtain a movement track of the object based on a plurality of sense images obtained by the sensing module; when the movement track conforms with one of the reference tracks, obtain, from the storage medium, one of the plurality of operation data sets to which said one of the reference tracks is associated with; and output a command that is related to said one of the plurality of operation data sets to the control unit. In response to receipt of the command, the control unit adjusts the rotational speed of the motor according to the command.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a block diagram illustrating a ceiling fan according to an embodiment of the disclosure.

FIG. 2 is a schematic view illustrating set-up of a fan device and a remote control of a ceiling fan according to an embodiment of the disclosure.

FIG. 3 is a schematic view illustrating a manner for operating the remote control.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly.

Throughout the disclosure, the term “coupled to” or “connected to” may refer to a direct connection among a plurality of electrical apparatus/devices/equipment via an electrically conductive material (e.g., an electrical wire), or an indirect connection between two electrical apparatus/devices/equipment via another one or more apparatus/devices/equipment, or wireless communication.

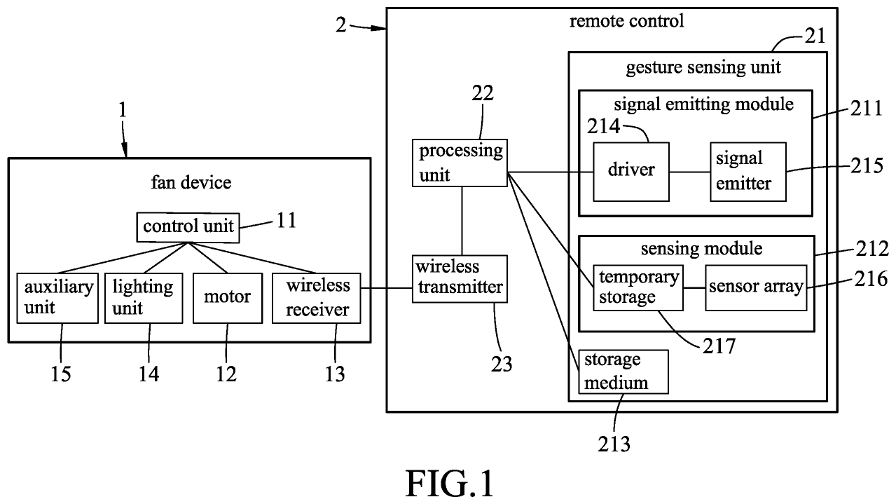

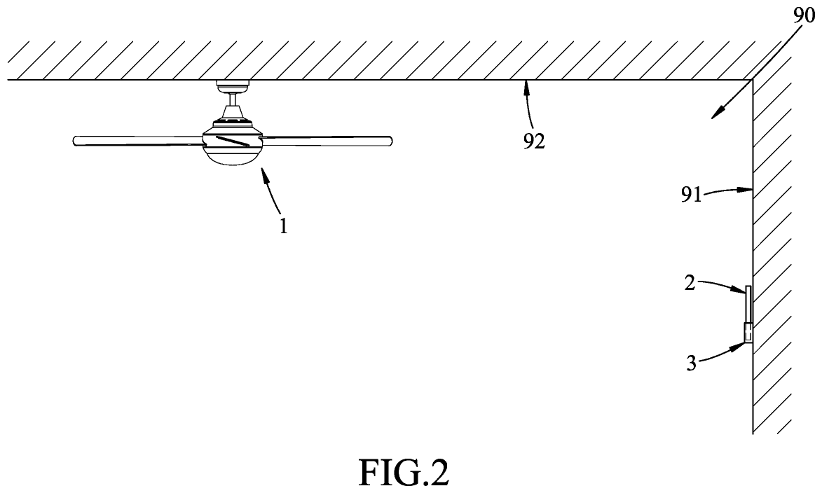

Referring to FIGS. 1 to 3, a ceiling fan according to an embodiment of the disclosure is provided. The ceiling fan is adapted to be disposed in a room 90, and is configured to adjust rotational speed of a motor 12 thereof according to a movement track 81 of an object 8. The object 8 may be, but not limited to, a hand of a user or any article that may be moved by the user to generate the movement track 81.

The ceiling fan includes a fan device 1 and a remote control 2, and may optionally include a holder 3. The fan device 1 includes the motor 12, a wireless receiver 13, and a control unit 11 that is electrically connected to the motor 12 and the wireless receiver 13 and that is configured to adjust rotational speed of the motor 12. In some embodiments, the fan device 1 may optionally include a lighting unit 14 and/or an auxiliary unit 15 that are both electrically connected to the control unit 11. In this embodiment, the room 90 has a wall 91 and a ceiling 92, the fan device 1 is mounted on and hanged from the ceiling 92, and the holder 3 is mounted on the wall 91.

The control unit 11 may be implemented by a central processing unit (CPU), a microcontroller (MCU), or any circuit capable of implementing functionalities discussed in this disclosure. The lighting unit 14 may be implemented by an LED, a traditional light bulb, or any other component that is configured to provide illuminating functions. The auxiliary unit 15 may be implemented by a dehumidifier, a humidifier, an air heater, an ozone generator, an ultraviolet germicidal lamp, or an aroma machine, and the respective function of the auxiliary unit 15 is to dehumidify, humidify, generate warm air, generate ozone, emit ultraviolet light, or generate fragrance.

The remote control 2 is coupled to the fan device 1, and includes a gesture sensing unit 21, a wireless transmitter 23, and a processing unit 22 that is electrically connected to the gesture sensing unit 21 and the wireless transmitter 23. The gesture sensing unit 21 includes a signal emitting module 211, a sensing module 212, and a storage medium 213 that are all electrically connected to the processing unit 22.

The signal emitting module 211 includes a signal emitter 215, and a driver 214 that is electrically connected to the signal emitter 215 and the processing unit 22. The processing unit 22 is configured to control the driver 214 to drive the signal emitter 215 to emit an emitting signal 210. The signal emitter 215 may be implemented by an infrared light emitting diode (LED) array that is configured to emit the emitting signal 210 in a form of infrared light, and the driver 214 is implemented by an LED driver. In some embodiments, the signal emitting module 211 may be implemented by a laser configured to emit laser light as the emitting signal 210, or a radar configured to emit radio waves as the emitting signal 210.

The sensing module 212 includes a temporary storage 217 (e.g., a volatile memory) that is electrically connected to the processing unit 22, and a sensor array 216 that is electrically connected to the temporary storage 217. The sensor array 216 is configured to receive the emitting signal 210 reflected by the object 8 as a sense signal, to obtain a sense image based on the sense signal thus received, and to store the sense image in the temporary storage 217.

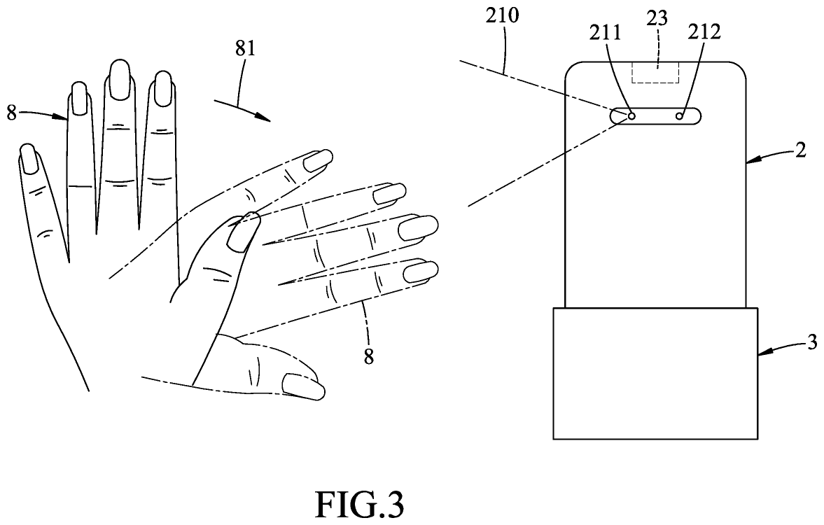

Referring to FIG. 3 for illustrating how to obtain the movement track 81 of the object 8 that moves from a first position represented by solid lines to a second position represented by dashed lines within a predetermined time period. The sensor array 216 first obtains a plurality of sense images, and temporarily stores the sense images in the temporary storage 217. The processing unit 22 then calculates the movement track 81 of the object 8 based on the sense images that are stored in the temporary storage 217 within the predetermined time period, thus obtaining the movement track 81.

For example, when the sense images obtained within the predetermined time period show a trend of the object 8 moving upward (may also be moving downward, moving leftward, moving rightward, moving up and down, moving left and right, increasing in size, decreasing in size, rotating clockwise, rotating counterclockwise, etc.), the movement track 81 is determined to be moving upward (may also be moving downward, moving leftward, moving rightward, moving up and down, moving left and right, approaching, leaving, rotating clockwise, rotating counterclockwise, etc.). As such, when the user is within a detecting range of the sensing module 212, the user may use his/her hand as the object 8, and perform different hand gestures (such as waving left and right) to generate the movement track 81.

It should be noted that the sensor array 216 may be implemented using a photoelectric sensor that is configured to suppress sensitivity to visible light and light with shorter wavelengths (i.e., the photoelectric sensor is mainly for detecting infrared waves). In this embodiment, the sensor array 216 is implemented by a pyro-electric infrared sensor that is configured to obtain the sense images when receiving an infrared wave that is in a specific range of wavelengths (e.g., a wavelength from 760 nm to 1 mm). In some embodiments, the sensor array 216 may be implemented using other types of photosensitive components provided with an infrared filter or an infrared coating, thus filtering out ambient light waves other than the sense signal so as to obtain the sense images with relatively better quality. Ways of filtering out the ambient light waves are not limited to the abovementioned examples.

In this embodiment, the sensing module 212 is an infrared sensing module to match with the signal emitting module 211 that is an infrared LED array. In other embodiments, the sensing module 212 may be a different type of sensing module configured to detect waves emitted by the signal emitting module 211 when the signal emitting module 211 is implemented by a laser or a radar. The abovementioned examples are capable of sensing in both bright and dim environments.

In this embodiment, the storage medium 213 stores a plurality of operation data sets that are related respectively to different operations of the motor 12, the lighting unit 14 and/or the auxiliary unit 15, and that are associated respectively with different reference tracks. For example, one of the operation data sets that is associated with a reference track related to moving upward with respect to a floor of the room 90 (i.e., toward the ceiling 92) is to increase rotational speed of the motor 12; another one of the operation data sets that is associated with a reference track related to approaching the sensor array 216 (i.e., moving forward) is to increase brightness of light emitted by the lighting unit 14. The operation data sets may also include, but not limited to, decreasing rotational speed of the motor 12, decreasing brightness of the light emitted by the lighting unit 14, controlling different operations of the auxiliary unit 15, etc. Each of the operation data sets includes data and/or parameters used for controlling operation of the motor 12, the lighting unit 14 or the auxiliary unit 15.

In some embodiments, the gesture sensing unit 21 is implemented without the signal emitting module 211, and the sensor array 216 is a charge-coupled device (CCD) that is configured to detect the ambient light (e.g., visible light) that is reflected by the object 8 as the sense signal.

The processing unit 22 is configured to operate in a control mode. In the control mode, the processing unit 22 first determines whether the movement track 81 conforms with any one of the reference tracks, and obtains a corresponding one of the operation data sets that is related to said one of the reference tracks from the storage medium 213 when the determination is affirmative. Then, the processing unit 22 outputs a command that includes the corresponding one of the operation data sets to the wireless receiver 13 via the wireless transmitter 23.

The processing unit 22 may be implemented by a CPU, an MCU, or any circuit capable of implementing functionalities discussed in this disclosure. The wireless receiver 13 and the wireless transmitter 23 may communicate with each other using short-range wireless technologies such as Bluetooth®, ZigBee, wireless fidelity (Wi-Fi), near field communication (NFC), or radio frequency (RF) of a predetermined frequency band (e.g., 433 MHZ)

The control unit 11 is configured to control operation of the motor 12, the lighting unit 14, or the auxiliary unit 15, according to the command that is received from the processing unit 22 via the wireless receiver 13. The command includes one of the operation data sets that is stored in the storage medium 213 and that is related to, but not limited to, adjusting the rotational speed of the motor 12, adjusting brightness of the light emitted by the lighting unit 14, or controlling a function of the auxiliary unit 15.

In some embodiments, the fan device 1 may be implemented without the wireless receiver 13, and correspondingly, the remote control 2 may be implemented without the wireless transmitter 23. Accordingly, the processing unit 22 is electrically connected to the control unit 11 via a wired connection (e.g., an electrically conductive material), and outputs the command to the control unit 11 through the wired connection.

In some embodiments, the processing unit 22 is further configured to operate in a setting mode. In the setting mode, the processing unit 22 is configured to add in a new operation data set to the storage medium 213 and associate the new operation data set with the movement track 81, or to replace one of the reference tracks that is stored in the storage medium 213 with the movement track 81. As such, the user may add in different hand gestures for controlling the fan device 1 to perform different functions, or replace one of the reference tracks that corresponds to one of the operation data sets with a preferred hand gesture for the user's convenience.

The holder 3 is separated from the fan device 1 and allows the remote control 2 to be disposed detachably on the holder 3. The user may place the remote control 2 on the holder 3 when using the remote control 2, or may detach the remote control 2 from the holder 3 and place the remote control 2 in other desired locations. In some embodiments, the remote control 2 is fixed on an operation surface (not shown) and does not require installation of the holder 3.

In summary, the remote control 2 is configured to be controlled by the user with hand gestures to adjust rotational speed of the motor 12, thus avoiding direct contact with the remote control 2 from the user. The sensing module 212 is configured to receive the sense signal in the form of ambient light, infrared light, laser light, or radio waves. The storage medium 213 stores the operation data sets that are associated respectively with different reference tracks, where the operation data sets provide different functions for operating the fan device 1. The processor 22 is configured to obtain the movement track 81 based on the sense images, and to output the command according to the movement track 81 for controlling functions of the fan device 1. The fan device 1 may include different auxiliary units 15, providing additional functions to the fan device 1 for the user to control using hand gestures, and the operation data sets are related to the additional functions provided by the auxiliary units 15. The processor 22 is further configured to enter a setting mode to add in new operation data set to the storage medium 213, or to replace one of the reference tracks with the movement track 81, allowing the user to customize according to their needs.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A ceiling fan comprising:
a fan device including a motor and a control unit that is electrically connected to said motor and that is configured to adjust rotational speed of said motor; and
a remote control including:
a gesture sensing unit including a sensing module that is configured to obtain a sense image based on a sense signal reflected by an object, and a storage medium that stores a plurality of operation data sets which are related to adjusting the rotational speed of said motor and different reference tracks which are respectively associated with the plurality of operation data sets,
a processing unit electrically connected to said sensing module, said storage medium and said control unit, and configured to:
obtain a movement track of the object based on a plurality of sense images obtained by said sensing module,
when the movement track conforms with one of the reference tracks, obtain, from said storage medium, one of the plurality of operation data sets to which said one of the reference tracks is associated with, and
output, to said control unit, a command that is related to said one of the plurality of operation data sets,
wherein, in response to receipt of the command, said control unit adjusts the rotational speed of said motor according to the command.

2. The ceiling fan as claimed in claim 1, wherein said remote control further includes a wireless transmitter electrically connected to said processing unit and configured to receive and transmit the command to said fan device, and said fan device further includes a wireless receiver electrically connected to said control unit and configured to receive the command from said wireless transmitter and transmit the command to said control unit.

3. The ceiling fan as claimed in claim 1, wherein said sensing module includes a temporary storage that is electrically connected to said processing unit, and a sensor array that is electrically connected to said temporary storage and that is configured to obtain the sense image based on the sense signal and to store the sense image in said temporary storage,
wherein said processing unit is configured to obtain the movement track based on the sense images that are stored in said temporary storage within a predetermined time period.

4. The ceiling fan as claimed in claim 3, wherein said sensing module is configured to receive ambient light reflected by the object as the sense signal.

5. The ceiling fan as claimed in claim 1, wherein said sensing module is configured to receive ambient light reflected by the object as the sense signal.

6. The ceiling fan as claimed in claim 1, wherein said gesture sensing unit further includes a signal emitting module that is configured to emit an emitting signal, and said sensing module is configured to receive the emitting signal reflected by the object as the sense signal.

7. The ceiling fan as claimed in claim 6, wherein said signal emitting module includes a signal emitter, and a driver that is electrically connected to said signal emitter and said processing unit,
wherein said processing unit is further configured to control said driver to drive said signal emitter to emit the emitting signal.

8. The ceiling fan as claimed in claim 7, wherein said signal emitting module is configured to emit the emitting signal in a form of one of infrared light, laser light, and radio waves.

9. The ceiling fan as claimed in claim 6, wherein said signal emitting module is configured to emit the emitting signal in a form of one of infrared light, laser light, and radio waves.

10. The ceiling fan as claimed in claim 1, further comprising a holder allowing said remote control to be disposed detachably on said holder.

11. The ceiling fan as claimed in claim 1, wherein said fan device further includes a lighting unit that is electrically connected to said control unit, said storage medium stores another plurality of operation data sets that are related to adjusting brightness of light emitted by said lighting unit and that are associated respectively with different reference tracks, and said processing unit is configured to select one of said another plurality of operation data sets that is associated with one of the reference tracks which conforms with the movement track from said storage medium, and to output another command that is related to said one of said another plurality of operation data sets to said control unit, and
wherein said control unit is configured to control said lighting unit to adjust brightness of the light emitted thereby according to said another command.

12. The ceiling fan as claimed in claim 1, wherein said fan device further includes an auxiliary unit that is electrically connected to said control unit and that is one of a dehumidifier, a humidifier, an air heater, an ozone generator, an ultraviolet germicidal lamp and an aroma machine, said storage medium stores another plurality of operation data sets that are related to operation of said auxiliary unit and that are associated respectively with different reference tracks, and said processing unit is configured to select one of said another plurality of operation data sets that is associated with one of the reference tracks which conforms with the movement track from said storage medium, and to output another command that is related to said one of said another plurality of operation data sets to said control unit, and
wherein said control unit is configured to control said auxiliary unit to operate according to said another command.

13. The ceiling fan as claimed in claim 1, wherein said processing unit is further configured to add in a new operation data set to said storage medium and associate the new operation data set with the movement track.

14. The ceiling fan as claimed in claim 1, wherein said processing unit is further configured to replace the reference track with the movement track.
